(19) United States
(12) Patent Application Publication
(10) Pub. No.: US 2026/0281693 A1
(43) Pub. Date: Sep. 17, 2026

(54) SERVICE SUBSCRIPTION OPTIMIZATION

(71) Applicant: Kyndryl, Inc., New York, NY (US)

(72) Inventors: Mouleswara Reddy Chintakunta, Bangalore (IN); Edward Pineda, Overland Park, KS (US); Omar Odibat, Cedar Park, TX (US)

(21) Appl. No.: 19/078,472

(22) Filed: Mar. 13, 2025

(51) Int. Cl. H04W 8/18; G06N 3/045

(52) U.S. Cl. CPC H04W 8/18; G06N 3/045

(57) ABSTRACT

A computer-implemented method for grouping one or more features of a first set of data associated with a customer into one or more sets of opportunity groups based on a feature evaluation using a first machine learning model; identifying a subset of the one or more sets of opportunity groups that meets at least one objective associated with the customer; and identifying one or more candidate services within the subset that exceed a correlation threshold for the one or more sets of opportunity groups based on the one or more features.

### BACKGROUND

Aspects of the present invention relate generally to optimizing data management service subscriptions.

There is a wide range of cloud data and monitoring services available today. The cloud data and monitoring services offer diverse services (e.g., solutions) to help businesses ensure the performance, security, and availability of their cloud infrastructure. These services provide comprehensive monitoring of cloud resources, including servers, networks, databases, and applications, offering real-time visibility, automated alerts, and detailed analytics. Cloud data and monitoring tools are designed to meet the varying needs of organizations at different scales, supporting both cloud-native and hybrid environments.

### SUMMARY

In a first aspect of the present invention, there is a computer-implemented method including: grouping one or more features of a first set of data associated with a customer into one or more sets of opportunity groups based on a feature evaluation using a first machine learning model; identifying a subset of the one or more sets of opportunity groups that meets at least one objective associated with the customer; and identifying one or more candidate services within the subset that exceed a correlation threshold for the one or more sets of opportunity groups based on the one or more features.

In another aspect of the present invention, there is a computer program product including one or more computer readable storage media having program instructions collectively stored on the one or more computer readable storage media. The program instructions are executable to: group one or more features of a first set of data associated with a customer into one or more sets of opportunity groups based on a feature evaluation using a first machine learning model; identify a subset of the one or more sets of opportunity groups that meets at least one objective associated with the customer; and identify one or more candidate services within the subset that exceed a correlation threshold for the one or more sets of opportunity groups based on the one or more features.

In another aspect of the present invention, there is a system including a processor, a computer readable memory, one or more computer readable storage media, and program instructions collectively stored on the one or more computer readable storage media. The program instructions are executable to: group one or more features of a first set of data associated with a customer into one or more sets of opportunity groups based on a feature evaluation using a first machine learning model; identify a subset of the one or more sets of opportunity groups that meets at least one objective associated with the customer; and identify one or more candidate services within the subset that exceed a correlation threshold for the one or more sets of opportunity groups based on the one or more features.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the present invention.

FIG. 5 shows a flow chart of an exemplary method in accordance with aspects of the present invention.

FIG. 6 shows a flow diagram of an exemplary method in accordance with aspects of the present invention.

FIG. 7 shows a flow diagram of an exemplary method in accordance with aspects of the present invention.

FIG. 8 shows a flow diagram of an exemplary method in accordance with aspects of the present invention.

FIG. 9 shows a flow diagram of an exemplary method in accordance with aspects of the present invention.

FIG. 10 shows a flow diagram of an exemplary method in accordance with aspects of the present invention.

### DETAILED DESCRIPTION

Aspects of the present invention relate generally to optimizing data-driven service subscriptions and capturing untapped data opportunities within data management systems. Implementations utilize artificial intelligence (AI) to identify cloud-computing service subscriptions that are available to, but not currently utilized by, a customer in an IT environment. In this manner, implementations of the invention provide a method for leveraging artificial intelligence (AI) to identify data management services (i.e., candidate services and/or candidate solutions), that are relevant to a customer but currently not being used by the customer, for optimizing an information technology (IT) environment. Implementations of the invention also provide a method for leveraging AI to identify data management services (i.e., candidate services), that are not currently offered by a data management service provider, for optimizing an IT environment.

A wide range of data management and data monitoring services are available today, including cloud monitoring services that offer diverse services (e.g., solutions) to help businesses ensure the performance, security, and availability of their cloud infrastructure. Existing cloud monitoring services follow an a la carte service model, where customers are charged separately for each specific feature or resource that is monitored and/or for each separate service that is used. This may allow for flexibility, but it is not cost-effective, especially for entities (e.g., businesses, corporations, service providers, cloud operators, etc.) with diverse and/or fluctuating monitoring needs. As a result, customers often pay for services that are not fully utilized, which leads to higher costs over time. Additionally, as the complexity of data management and data monitoring environments increases, customers (e.g., corporation, entity, organization, etc.) may purchase or subscribe to multiple services to cover different aspects of their infrastructure, resulting in fragmented pricing and inefficiencies.

Furthermore, with the a la carte service model, entities are often unaware of the broader range of services available, which can limit the ability to optimize data management and data monitoring efforts. Many existing cloud monitoring providers offer a variety of tools and features that could enhance visibility, performance, and security, but these services may not be known or easily discoverable. As a result, customers only subscribe to the specific features that are familiar and overlook complementary services that could provide additional value or streamline operations. This lack of awareness prevents customers from fully leveraging data management and data monitoring services, leading to missed opportunities for cost savings, improved efficiency, and/or enhanced security. Therefore, customers suffer from problems including missed opportunities for cost savings, poor efficiency (i.e., inefficiency), and a lack of security.

For customers focusing on specific objectives, such as Financial Operations (FinOps) or Sustainability Operations (SustainOps), identifying opportunities to optimize these areas can be both critical and complex. These objectives often require specialized monitoring and reporting capabilities that go beyond traditional cloud monitoring and involve managing costs, resource utilization, and environmental impact in highly nuanced ways. For instance, in FinOps, customers utilize detailed insights into cloud spending patterns, budget forecasts, and cost allocation across teams or services. Similarly, SustainOps involves tracking energy consumption, carbon emissions, and the sustainability of cloud infrastructure. The complexity arises because known a la carte monitoring services do not provide a unified view or specific metrics needed to manage these objectives effectively. As a result, identifying opportunities for improvement requires a more integrated approach, which known data management services do not fully support. For example, existing data management services do not fully support optimizing a customer’s operational efficiency, improving a customer’s resource allocation, enhancing a customer’s cost management, and minimizing a customer’s environmental impact. This makes it difficult and complex for customers to uncover the most effective strategies for achieving a customer’s operational efficiency goals and resource allocation goals. Such systems suffer from the problem of not being able to determine the most effective strategies for achieving goals because conventional systems do not provide and/or support a unified view or specific metrics for managing business objectives.

Further, entities struggle to expand operations into new markets without a clear understanding of customer data, which is crucial for making informed decisions and tailoring strategies for success. Known methods do not provide robust analytics and insights. Without robust analytics and insights, entities have difficulties identifying customer preferences, market trends, and regional demand variations. This lack of clarity can hinder a service provider’s ability to optimize product (e.g., service) offerings, marketing efforts, and customer support in new markets. Without access to detailed, real-time customer data, customers and/or service providers may miss critical opportunities or face challenges in adjusting to the unique dynamics of different regions. Accordingly, entities rely on methods that offer fragmented or siloed systems and do not offer a comprehensive view of customer behavior across markets. Again, existing systems suffer from the problem of not being able to determine the most effective strategies for achieving goals because known systems do not provide and/or support a unified view or specific metrics for managing business objectives.

Aspects of the present invention address the above-noted problems by optimizing data-driven service subscriptions for a customer based on unique data, characteristics, and objectives, thereby providing the ability to identify untapped data opportunities within data management systems enhances an ability to meet objectives. In this manner, aspects of the invention provide an improved customer experience for data management managers and/or customers over what existing methods can achieve, by providing personalized service offerings (e.g., a data management service offering) tailored for the needs of customers. Through these aspects, the present invention improves data management system technologies, including the technology for optimizing data-driven service subscriptions and capturing untapped data opportunities within data management systems.

According to an aspect of the present invention, there is a computer-implemented method for leveraging artificial intelligence (AI) to identify candidate services (e.g., services and/or solutions relevant to a customer but currently not being used by the customer) for optimizing an information technology (IT) environment, the method includes receiving, from a datastore, one or more sets of relevant data; evaluating, using at least one machine learning model (e.g., a model that iteratively combines and refines feature subsets to improve model performance by enhancing relevant information while reducing redundancy, such as a recursive feature fusion model), the one or more sets of relevant data to group one or more features of the one or more sets of data into one or more sets of opportunity groups (e.g., groups of similar services); predicting, using at least one neural network, a subset of the one or more sets of opportunity groups best achieves one or more objectives (e.g., improved efficiency, reduced cost, improved sustainability, and more); identifying, by an opportunity language model and based on the one or more evaluated features, a set of candidate services best correlating to the one or more sets of opportunity groups; and notifying a user of the set of unutilized services.

According to an aspect of the present invention, the foregoing unutilized services are grouped based on relevancy to the one or more IT objectives. According to an aspect of the present invention, the foregoing one or more sets of relevant data may include cost data, asset data, metric data, application log data, and/or miscellaneous data.

According to an aspect of the present invention, the foregoing one or more evaluated features of the one or more sets of relevant data may include numeric features, categorical features, time series features, textual data features, and/or other features. According to an aspect of the present invention the foregoing recursive feature fusion may employ one or more evaluation methods, including correlation, Least Absolute Shrinkage and Selection Operator L1 (LASSO L1) models, Chi-square models, wrapper models such as forward selection, backward elimination, and recursive feature elimination (RFE), and/or other similar models).

Implementations of the present invention are necessarily rooted in computer technology. For example, evaluating features using a machine learning model and/or identifying opportunity groups that meet objectives related to (e.g., associated with) the first customer or service provider using a machine learning model, are computer-based, are individually and collectively complex, and cannot be performed in the human mind. Given the scale and complexity required to perform the foregoing tasks, it is simply not possible for the human mind, or for a person using pen and paper, to perform the number of calculations involved in: recursive feature fusion models (e.g., a technique that iteratively combines and refines feature subsets to improve model performance by enhancing relevant information while reducing redundancy, including correlation models, Least Absolute Shrinkage and Selection Operator L1 (LASSO L1) models, Chi-square models, and/or wrapper models such as forward selection, backward elimination, and recursive feature elimination (RFE)); neural networks (e.g., multimodal neural networks, graph neural networks, long short-term memory networks, and/or recursive neural networks); and data transformation using a transformer block. As used herein, a transformer block refers to a computational unit in a deep learning model that helps the system focus on important parts of the data by analyzing relationships between different elements in a sequence. The transformer block enables the model to capture complex relationships between input elements, while efficiently handling large-scale data, which would be infeasible for manual calculation or simple computational tools.

It should be understood that, to the extent implementations of the present invention collect, store, or employ personal information provided by, or obtained from, individuals (for example, any customer content and/or customer data that may include personal information, personal communications, personal preferences, identifying information, etc.), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the "C" programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

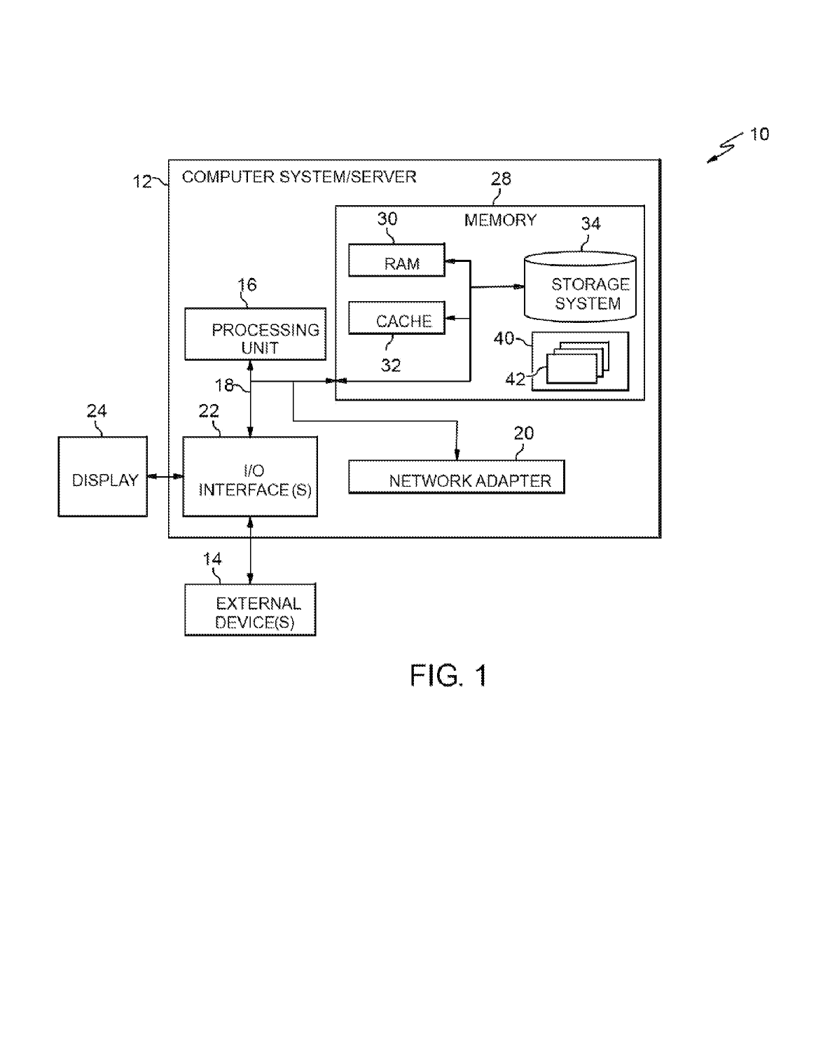

Referring now to FIG. 1, a schematic of an example of a cloud computing node is shown. Cloud computing node 10 is only one example of a suitable cloud computing node and is not intended to suggest any limitation as to the scope of use or functionality of embodiments of the present invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a "hard drive"). Although not shown, a magnetic disk drive for reading from and writing to a removable, non-volatile magnetic disk (e.g., a "floppy disk"), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the present invention.

Program/utility 40, having a set (at least one) of program modules 42, may be stored in memory 28 by way of example, and not limitation, as well as an operating system, one or more application programs, other program modules, and program data. Each of the operating systems, one or more application programs, other program modules, and program data or some combination thereof, may include an implementation of a networking environment. Program modules 42 generally carry out the functions and/or methodologies of embodiments of the present invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to microcode, device drivers, redundant processing units, external disk drive arrays, RAID systems, tape drives, and data archival storage systems, etc.

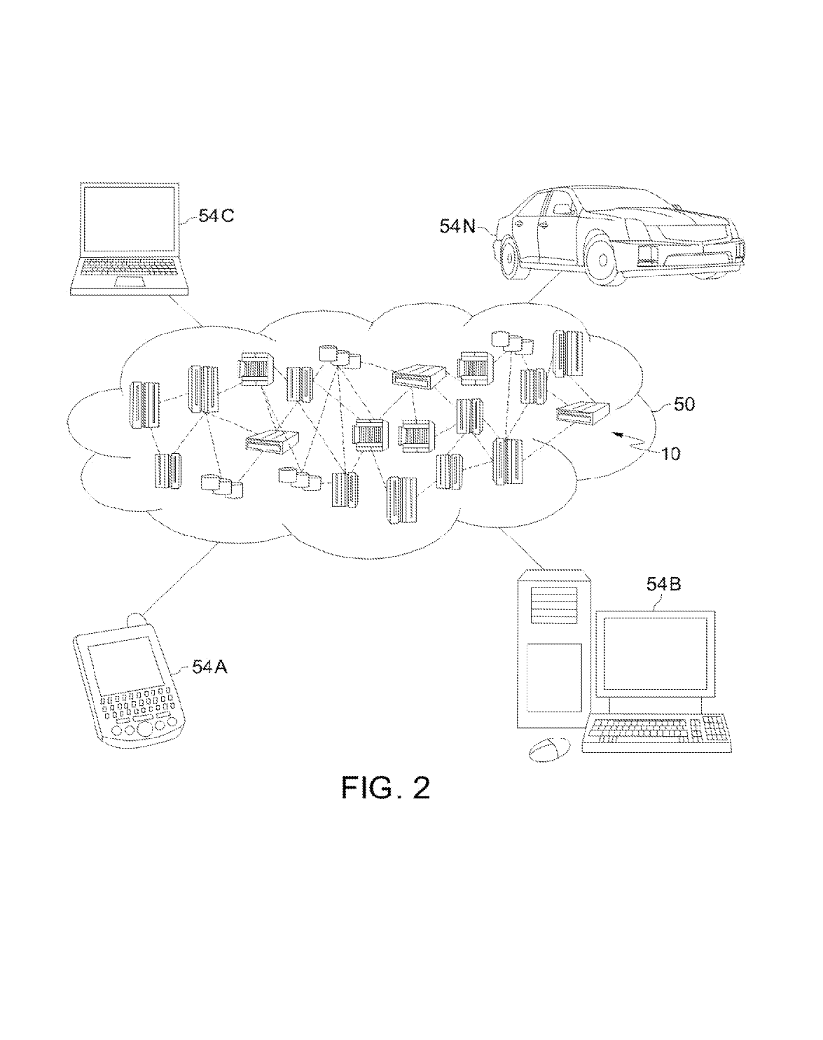

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

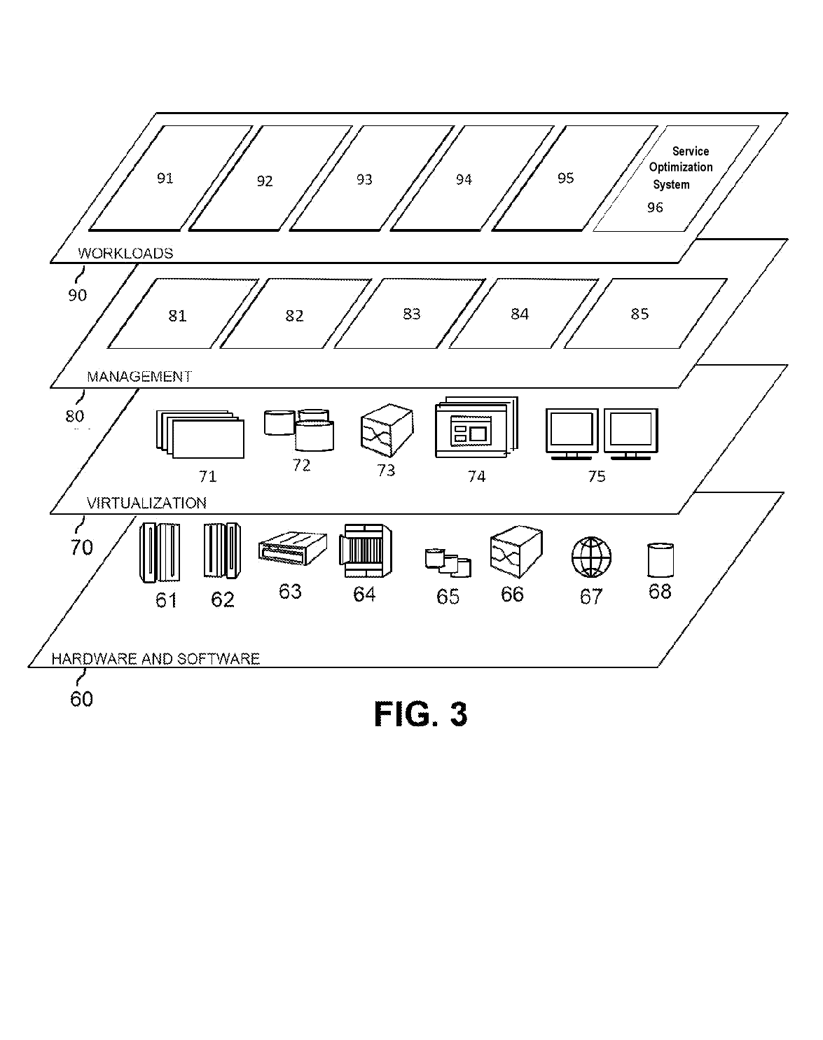

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the present invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and service optimization system 96.

Implementations of the present invention may include a computer system/server 12 of FIG. 1 in which one or more of the program modules 42 are configured to perform (or cause the computer system/server 12 to perform) one of more functions of service optimization system 96 of FIG. 3. For example, the one or more of the program modules 42 may be configured to: group one or more features of the a first set of data associated with a first customer into one or more sets of opportunity groups based on a feature evaluation using a first machine learning model (e.g., a trained recursive feature fusion model), trained by iteratively refining a set of training features until the model meets a predefined level of accuracy, and identify, using at least one neural network, a subset of the one or more sets of opportunity groups that meets at least one objective associated with the first customer.

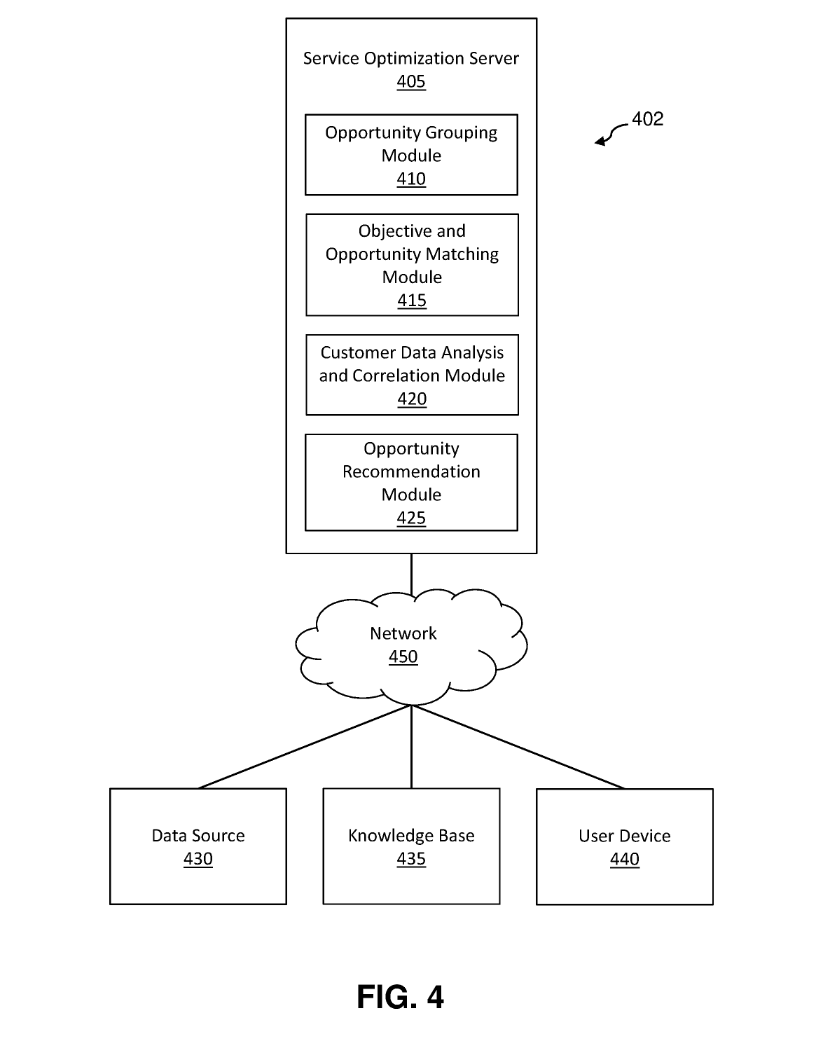

FIG. 4 shows a block diagram of exemplary environment 402 in accordance with aspects of the present invention. In embodiments, the environment 402 includes service optimization server 405, data source 430, a knowledge base 435, user device 440, and a network 450.

Service optimization server 405 may comprise one or more instances of computer system/server 12 of FIG. 1. In another example, service optimization server 405 may comprise one or more virtual machines or containers running on one or more instances of computer system/server 12 of FIG. 1. In embodiments, service optimization server 405 communicates with data source 430, knowledge base 435, and user device 440 via network 450, which may comprise cloud computing environment 50 of FIG. 2. In embodiments, data source 430 comprises one or more instances of hardware and software components of hardware and software layer 60 of FIG. 3. In embodiments, knowledge base 435 comprises one or more instances of hardware and software layer 60 of FIG. 3. In embodiments, knowledge base 435 comprises a corpus of data (i.e., a collection of data) used to train and evaluate machine learning models. In embodiments, user device 440 comprises an instance of an end user device such as, for example, personal digital assistant (PDA) or cellular telephone 54A, desktop computer 54B, laptop computer 54C, and/or automobile computer system 54N of FIG. 2. In embodiments, there may be plural different instances of user device 440. The different instances of user device 440 may be used by different users, product managers, system administrators, and/or other users that may access service optimization server 405, respectively.

In embodiments, service optimization server 405 comprises opportunity grouping module 410, objective and opportunity matching module 415, customer data analysis and correlation module 420, and opportunity recommendation module 425, each of which may comprise one or more program modules such as program modules 42 described with respect to FIG. 1. Service optimization server 405 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In accordance with aspects of the present invention, service optimization server 405 is configured to receive one or more data sets associated with a customer (e.g., corporation, entity, organization, etc.). In embodiments, the one or more data sets may include, for example, cost data (e.g., cloud service usage costs, subscription fees, cost allocation, cost projections, etc.), asset data (e.g., hardware inventory, software licenses, cloud assets, asset lifecycles, etc.), metric data (e.g., system performance metrics, application metrics, user activity metrics, network traffic, etc.), application log data (e.g., error logs, transaction logs, access logs, system event logs, etc.), other data associated with the customer’s service subscriptions (e.g., service-level agreement data, subscription usage data, license compliance data, etc.), and/or data associated with a service provider’s subscription offerings.

In accordance with aspects of the present invention, opportunity grouping module 410 is configured to group one or more features of a first set of data associated with a first customer into one or more sets of opportunity groups based on a feature evaluation using a first machine learning model (e.g., correlation models, Least Absolute Shrinkage and Selection Operator L1 (LASSO L1) models, Chi-square models, and/or wrapper models such as forward selection, backward elimination, and recursive feature elimination (RFE)). In embodiments, opportunity grouping module 410 performs this grouping by marking the features as being related and combining and/or coalescing the features into one or more sets of opportunity groups. Features may be categorized based on numerical data (e.g., values that represent quantities and/or can be used in mathematical operations), categorical data (e.g., variables that represent categories or groups and do not have inherent order or mathematical meaning, though in embodiments, they can be ordinal), timeseries data (e.g., data points that are ordered in time, such as daily, hourly, or monthly), text data (e.g., unstructured data represented by natural language), and/or any other category that could describe features of a data set.

In embodiments, the foregoing grouping may be performed by opportunity grouping module 410 based on a feature evaluation using a recursive feature fusion model (e.g., correlation models, LASSO L1 models, Chi-square models, and/or wrapper models such as forward selection, backward elimination, and RFE), or any other machine learning model that combines features from different sources or modalities in a recursive manner to improve prediction accuracy or enhance representation learning (e.g., multimodal neural networks, graph neural networks, long short-term memory networks, and/or recursive neural networks).

In embodiments, the recursive feature fusion model may be trained by iteratively refining the set of features by applying different evaluation techniques (e.g., LASSO L1, Chi-square, wrapper models, and RFE) until the most relevant features are identified, which ultimately improves the performance of the resulting machine learning model. In embodiments, in training the recursive feature fusion model, the process begins with an initial set of features, which are then evaluated using various feature selection techniques such as LASSO L1, Chi-square, wrapper models, RFE, and/or other techniques known in the art. These techniques iteratively refine the set of features by removing less relevant ones and retaining those that contribute most to the predictive accuracy of the model. This iterative process continues until the model converges on a set of features that maximizes performance (e.g., accuracy). As used herein, the term converges refers to the process where the recursive feature fusion model reaches a point where further iterations of feature evaluation and refinement no longer significantly improve the model’s performance (e.g., accuracy). When the model converges, the model is trained using the optimized feature set to enhance prediction quality and generalization.

In embodiments, the iterative training process continues until a predetermined level of accuracy is met. The level of accuracy measures model performance, typically in terms of its ability to correctly predict outcomes or classify data based on the selected features. This accuracy is often assessed using metrics such as precision, recall, F1-score, or mean squared error. The predetermined level of accuracy determines when the iterative feature refinement process should stop, ensuring that the model has reached a point where further feature adjustments do not significantly improve its performance, thereby optimizing both prediction quality and computational efficiency.

As used herein, LASSO L1 models are a type of linear regression that uses L1 regularization to prevent overfitting by adding a penalty to the absolute values of the model's coefficients. Chi-square models refer to a statistical test(s) used to determine a significant association exists between categorical variables. The Chi-square model (i.e., test) compares observed frequencies of categories in a contingency table to expected frequencies under an assumption of no association.

In accordance with aspects of the present invention, the objective and opportunity matching module 415 is configured to identify a subset of the one or more sets of opportunity groups that meets at least one objective associated with a customer. As used herein, an objective associated with the customer refers to a specific goal or target that the customer aims to achieve, such as maximizing profit, improving performance, or minimizing risk, depending on the context. In embodiments, objectives may include cost visibility, cost optimization, budgeting, forecasting, cost allocation, governance, compliance, resource efficiency, and/or any objective associated with an improved customer experience, increased return on investment, strategic decision making, enhanced customer retention, innovation, and/or product development. In embodiments, the objective is received as an input from the customer. In embodiments, the objective and opportunity matching module 415 uses at least one second machine learning model (e.g., LASSO L1, Chi-square, wrapper models, and RFE) to identify a subset of the opportunity groups that meets a customer’s objective.

In embodiments, objective and opportunity matching module 415 identifies the subset using at least one neural network (e.g., multimodal neural networks, graph neural networks, long short-term memory networks, and/or recursive neural networks). In embodiments, at least two neural networks may be used, a policy network that directly learns a mapping from states and a value network that learns a mapping from states (or state-action pairs) to a scalar value (e.g., Q-learning models, deep Q-network (DQN) models, etc.).

In accordance with aspects of the present invention, the customer data analysis and correlation module 420 is configured to identify different types of candidate opportunities from customer data by comparing a customer’s needs against services that are available from one or more service providers. In embodiments, customer data analysis and correlation module 420 may be configured to identify at least one candidate solution and/or candidate opportunity (e.g., an unused solution and/or an unused opportunity) that has a correlation score that exceeds a correlation threshold for an opportunity group. As used herein, candidate services (e.g., data management services and/or solutions) refer to services that are relevant and/or available to a customer but are not currently known and/or being used by the customer. Candidate opportunities refer to opportunities relevant to a service provider that are not currently being offered by the service provider to its customers. One or more lists of candidate services and/or candidate opportunities may be received and/or obtained from a data management service provider, a data repository, and/or a data corpus that stores one or more lists of services and/or opportunities. In embodiments, the one or more lists of candidate services and/or candidate opportunities may be assembled and/or created from other entities (e.g., data management providers and/or data management customers).

In embodiments, customer data analysis and correlation module 420 may be further configured to determine a correlation score for the one or more features using at least one correlation model. As used herein, a correlation score refers to a measure of correlation between the one or more features and features of the opportunity groups. In embodiments, the correlation score quantifies the degree of relationship or association between two or more features, indicating how strongly they are related or how one feature may predict or vary with another.

In embodiments, the customer data analysis and correlation module 420 may be further configured to bundle the identified candidate services and/or candidate opportunities based on features of the candidate services and/or candidate opportunities. In embodiments, customer data analysis and correlation module 420 may use a clustering algorithm to group, bundle, and/or combine relevant services into a single group based on features like a core objective, functional data, correlation scores, etc.

In accordance with aspects of the present invention, the opportunity recommendation module 425 is configured to identify a list of candidate service offerings (e.g., service provider offerings). As used herein, candidate service offerings refer to services that a customer may subscribe to for cost savings, analysis of business, and more, that are not currently offered by the service provider. Candidate service offerings may also refer services that a service provider may seek to offer based on a determined demand for specific services and/or types of services. For example, opportunity recommendation module 425 may identify candidate service offerings for a service provider by identifying a cloud cost optimization solution in response to an increased demand from customers seeking to reduce their cloud spending. In such embodiments, opportunity recommendation module 425 may make this identification based on services identified to meet the objectives of one or more customers. In embodiments, the identification is further based on trends in customer usage patterns, and/or growing interest in sustainability, etc., leading to the development of tailored services (e.g., solutions) that address those needs.

In embodiments, opportunity recommendation module 425 may be configured to match the identified candidate services and/or candidate opportunities and the clustered groups, as grouped by customer data analysis and correlation module 420, with services that are offered by service providers (e.g., lists provided by a data management service provider, obtained from a data repository, and/or obtained at a data corpus that stores one or more lists of services and/or opportunities). In embodiments, services that are relevant to a customer but are currently unused by the customer (i.e., unused services) are compared with services that are offered by a service provider to determine whether the services offered by the service provider may solve a customer need.

In embodiments, opportunity recommendation module 425 is configured to determine a match correlation score for the identified candidate services and/or candidate opportunities and the clustered groups based on how closely they match the list of services offered by service providers. For example, a match confidence score (e.g., a correlation score) that is greater than 95% would indicate a high correlation between the identified candidate services and/or candidate opportunities and the clustered groups with a service on the list of services offered by the service provider. As noted above, a correlation score refers to a measure of correlation between the one or more features and features of the opportunity groups. In embodiments, the correlation score measures how closely the identified candidate services and/or candidate opportunities and clustered groups align with the services offered by service providers. In embodiments, a higher correlation score indicates a stronger match, while a lower score suggests less relevance between the candidate services and the services currently available. The score helps assess the likelihood that a given solution or opportunity is a good fit for a service provider’s service offerings and/or for a customer’s needs.

In embodiments, the opportunity recommendation module 425 is configured to automatically modify a customer’s data management service subscription by adding one or more candidate services that have a match confidence score (e.g., a correlation score) that exceeds a correlation threshold to the service subscription associated with the customer. The match confidence score (e.g., a correlation score) exceeds the correlation threshold when the confidence score surpasses the predefined correlation threshold. For example, if a predetermined threshold is set at 90% correlation, then scores at 90% or above exceed the correlation threshold. In embodiments, the opportunity recommendation module 425 is configured to automatically modify a service provider’s service offerings by adding one or more candidate opportunities that have a match confidence score (e.g., a correlation score) that exceeds a correlation threshold for one or more customers.

In embodiments, opportunity recommendation module 425 may be configured to notify a customer of and/or about the candidate services that exceed the correlation threshold. In such embodiments, the customer’s service subscription may be modified based on a user response to the notification. In embodiments, when the user is notified of the candidate services that exceed the correlation threshold, the user may be given an option to modify the service subscription to include the candidate services and/or candidate opportunities and/or to deny the proposed modification. Similarly, opportunity recommendation module 425 may be configured to notify a service provider about the candidate opportunities that exceed the correlation threshold.

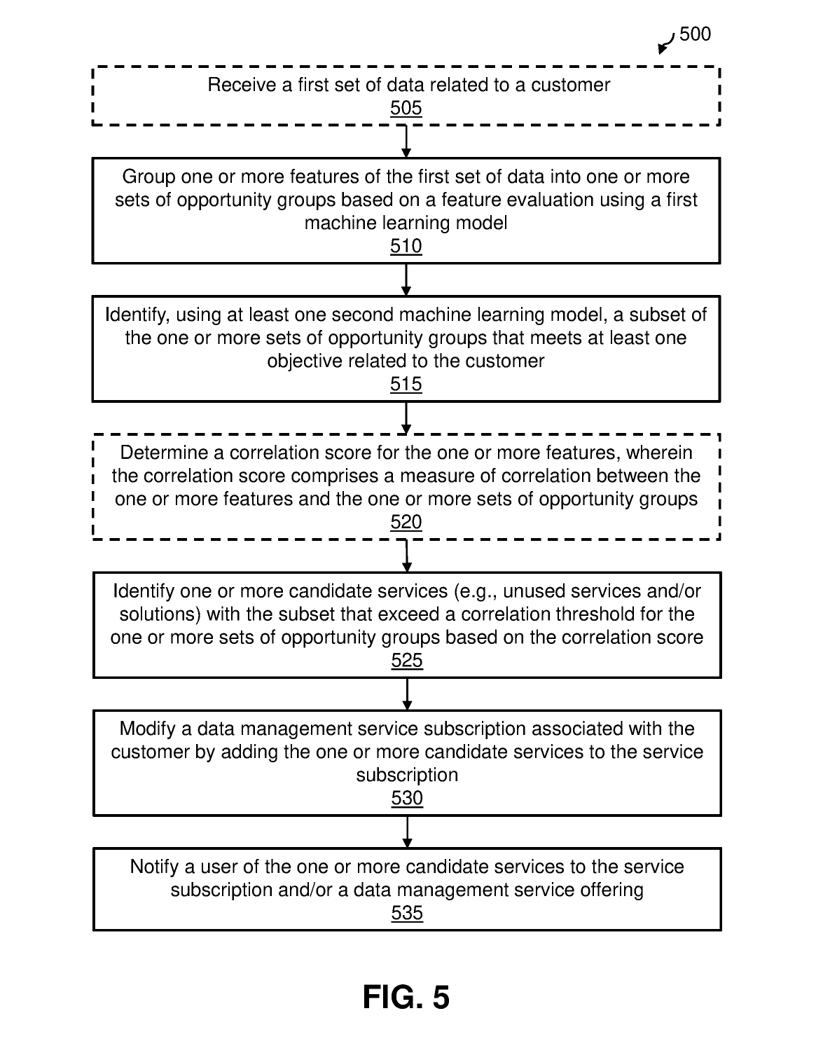

FIG. 5 shows a flowchart of an exemplary method 500 in accordance with aspects of the present invention. Steps of the method may be carried out in the environment of FIG. 4 and are described with reference to elements depicted in FIG. 4.

At step 505, the service optimization server of FIG. 4 is configured to receive, access, or obtain one or more data sets associated with a customer from a service provider, a data repository, and/or a data corpus that stores one or more lists of data sets associated with entities. In further embodiments, step 505 is an optional step, as indicated by the dotted line. As provided above, the one or more data sets may include, for example, cost data (e.g., cloud service usage costs, subscription fees, cost allocation, cost projections, etc.), asset data (e.g., hardware inventory, software licenses, cloud assets, asset lifecycles, etc.), metric data (e.g., system performance metrics, application metrics, user activity metrics, network traffic, etc.), application log data (e.g., error logs, transaction logs, access logs, system event logs, etc.), and other data associated with the customer’s data management service subscriptions (e.g., service-level agreement data, subscription usage data, license compliance data, etc.).

At step 510, the opportunity grouping module 410 of FIG. 4 is configured to group, combine, coalesce, and/or mark with any indication as being related, one or more features of the data sets into one or more sets of opportunity groups. As provided above, the features may be categorized based on numerical data (e.g., values that represent quantities and/or can be used in mathematical operations), categorical data (e.g., variables that represent categories or groups and do not have inherent order or mathematical meaning, though in embodiments, they can be ordinal), timeseries data (e.g., data points that are ordered in time, such as daily, hourly, or monthly), text data (e.g., unstructured data represented by natural language), and/or any other category that could describe features of a data set.

In embodiments, step 510 may be performed by the opportunity grouping module 410 based on a feature evaluation using a recursive feature fusion model (e.g., correlation models, Least Absolute Shrinkage and Selection Operator L1 (LASSO L1), Chi-square models, and/or wrapper models such as forward selection, backward elimination, and recursive feature elimination (RFE)) or any other machine learning model that combines features from different sources or modalities in a recursive manner to improve identification (e.g., prediction) accuracy or enhance representation learning (e.g., multimodal neural networks, graph neural networks, long short-term memory networks, and/or recursive neural networks).

At step 515, the objective and opportunity matching module 415 of FIG. 4 is configured to identify and/or predict a subset of the one or more sets of opportunity groups that meets at least one objective associated with a customer. As explained above, an objective associated with the customer refers to a specific goal or target that the customer aims to achieve, such as maximizing profit, improving performance, or minimizing risk, depending on the context. In embodiments, step 515 may further include identifying the subset using at least one neural network (e.g. multimodal neural networks, graph neural networks, long short-term memory networks, and/or recursive neural networks). In embodiments, at least two neural networks may be used, a policy network that directly learns a mapping from states and a value network that learns a mapping from states (or state-action pairs) to a scalar value (e.g., Q-learning models, deep Q-network (DQN) models, etc.).

At step 520, the customer data analysis and correlation module 420 of FIG. 4 is configured to determine a correlation score for the one or more features using at least one correlation model. In further embodiments, step 520 is an optional step, as indicated by the dotted line. As provided above, a correlation score refers to a measure of correlation between the one or more features and features of the opportunity groups. In embodiments, the correlation score quantifies the degree of relationship or association between two or more features, indicating how strongly they are related or how one feature may predict or vary with another. At step 525, the objective and opportunity matching module 415 of FIG. 4 is configured to identify one or more candidate services and/or candidate opportunities that exceed a confidence threshold (e.g., a correlation threshold) for the one or more sets of opportunity groups based on the one or more features. As used herein, a confidence threshold refers to a predefined value and/or criterion that determines a minimum level of certainty and/or reliability required for a solution or opportunity to be considered valid or relevant. In embodiments, the confidence threshold (e.g., a correlation threshold) may be set by a customer. For example, a customer may indicate that only correlation scores of 95% or above (i.e., a correlation between the identified candidate services and/or candidate opportunities and the clustered groups with a service on the list of services offered by the service provider has a confidence score of 95% or above) will be considered for adding to a subscription service associated with the customer. In embodiments, the confidence threshold is based on a correlation score, and only those unused services, unused opportunities, and/or opportunity groups that exceed this threshold are considered for further actions, such as adding them to a service subscription and/or notifying the user. The threshold ensures that only highly confident and/or strongly correlated services are included in the decision-making process. In embodiments, a system may determine a default confidence threshold.

At step 530, the opportunity recommendation module 425 of FIG. 4 is configured to modify a service subscription associated with the customer by adding one or more candidate services and/or candidate opportunities that exceed a correlation threshold to the service subscription associated with the customer. In embodiments, modifying the service subscription associated with the customer may occur in response to a user input (e.g., a user response). For example, in embodiments, opportunity recommendation module 425 may notify a user of the one or more candidate services and/or candidate opportunities that exceed the confidence threshold. In such embodiments, a user may choose to modify the service subscription in response to the notification. Therefore, opportunity recommendation module 425 may be configured to, responsive to a user response to the notification, modify a data management service subscription associated with the customer by adding the one or more candidate services.

At step 535, the opportunity recommendation module 425 of FIG. 4 is configured to notify a user of the one or more candidate services and/or candidate opportunities that exceed the confidence threshold. In such embodiments, the service subscription associated with the customer may be modified based on a user response to the notification. In embodiments, when the user is notified of the candidate services and/or candidate opportunities that exceed the correlation threshold, the user may be given an option to modify the service subscription to include the candidate services and/or to deny the proposed modification. In embodiments where a candidate opportunity is presented, a user may be given an option to modify a service offering to include the candidate services for its customers and/or to deny the proposed modification. In embodiments, a user may be notified via email, text message, an application notification, a system alert, or any other means for transmitting a message to a user device (e.g., user device 240).

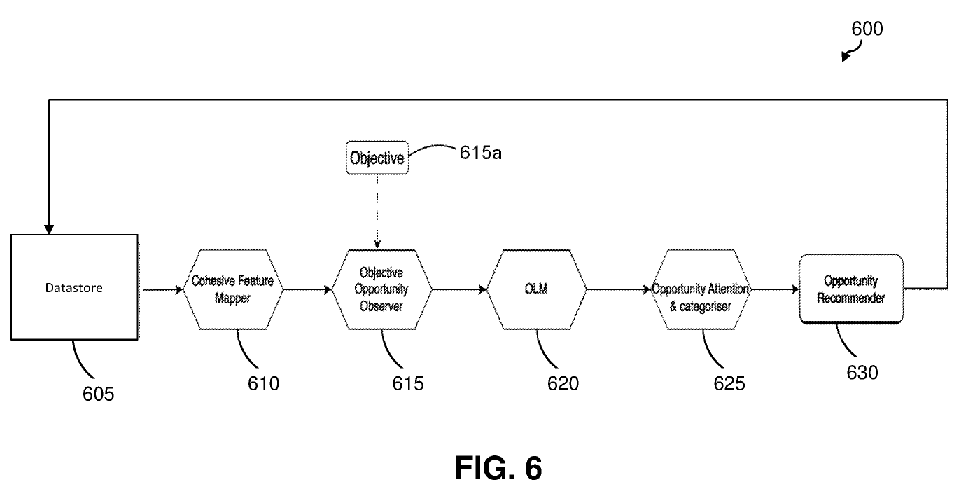

FIG. 6 shows a flow diagram of exemplary method 600 in accordance with aspects of the present invention. Steps of the method may be carried out in the environment of FIG. 4 and may include one or more steps, as described with respect to method 500 of FIG. 5. For example, datastore 605 (e.g., one or more implementations of service optimization server 405 of FIG. 4) is used to obtain and/or receive a set of data associated with a customer. In embodiments, the set of data is received and/or obtained to be evaluated and to potentially identify a set of opportunities based on the customer’s business objectives. In embodiments, the datastore 605 receives at least one set of data associated with a customer in accordance with step 505 of FIG. 5.

Cohesive feature mapper 610 (e.g., one or more implementations of opportunity grouping module 410 of FIG. 4) identifies the types of features that can be grouped combined, coalesced, and/or marked to form a new opportunity that can be fed into an opportunity language model (OLM). In embodiments, cohesive feature mapper 610 identifies and groups the features in accordance with step 510 of FIG. 5.

Objective opportunity observer 615 (e.g., one or more implementations of objective and opportunity matching module 415 of FIG. 4) receives and/or accesses objectives 615a and identifies and prioritizes grouped feature sets that map to objectives 615a. In some embodiments, objective opportunity observer 615 may apply a weighting to specific features that are more closely associated with (i.e., correlated to) an objective of a customer. For example, if the objective of the customer were to reduce costs, features that were available for lower prices may be assigned a larger weight. In embodiments, objective opportunity observer 615 identifies and groups the features in accordance with step 515 of FIG. 5.

Opportunity language model (OLM) 620 (e.g., one or more implementations of customer data analysis and correlation module 420 of FIG. 4) identifies opportunities using a transformer block to process the embeddings, using self-attention (e.g., feature attention) and feedforward layers, to capture complex relationships and dependencies within the sequence. As used herein, a transformer block refers to a computational unit in a deep learning model that helps the system focus on important parts of the data by analyzing relationships between different elements in a sequence. As noted above, the transformer block uses self-attention to weigh the significance of each element and feedforward layers to process and transform the data, enabling the model to better understand complex patterns. This process allows the OLM 620 to identify and categorize opportunities accurately and efficiently. Embeddings refer to data representations (such as words, phrases, or other types of information) as dense, fixed-size vectors of numbers, where similar data points are mapped to similar vectors in a continuous vector space. Self-attention (e.g., feature attention) refers to a mechanism where each element in a sequence is compared to every other element to determine its relevance, allowing the model to focus on important parts of the input when making predictions or processing data. Feedforward layers refer to a neural network where the input data passes through transformations (e.g., weighted sums and activation functions) in a forward direction, without any loops or feedback connections.

Opportunity attention & categorizer 625 (e.g., one or more implementations of customer data analysis and correlation module 420) categorizes the relevant opportunities into a single group. In embodiments OLM 620 identifies opportunities by analyzing and processing the data (e.g., customer data) using deep learning techniques (e.g., a transformer block) whereas opportunity attention & categorizer 625 categorizes these opportunities into one or more groups. In embodiments, OLM 620 and opportunity attention & categorizer 625 perform these tasks in accordance with steps 520 and 525 of FIG. 5.

Opportunity recommender 630 (e.g., one or more implementations of opportunity recommendation module 425 of FIG. 4) recommends the opportunities (e.g., objective-driven opportunities) to a service provider, to meet the objectives of one or more customers. In embodiments, opportunity recommender 630 may modify the service provider’s service offerings by adding one or more services to the service provider’s service offerings. In embodiments, opportunity recommender 630 provides this recommendation and/or modification in accordance with steps 530 and 535 of FIG. 5.

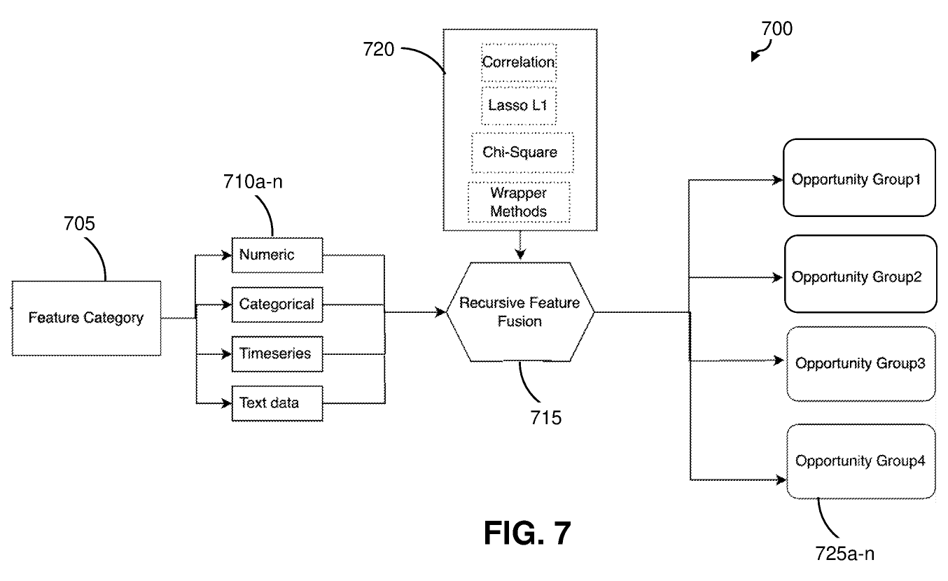

FIG. 7 shows exemplary flow diagram of exemplary environment 700 in accordance with aspects of the present invention. Steps of the method may be carried out in the environment of FIG. 4 and are described with reference to elements depicted in FIG. 4 and may include one or more steps, as described with respect to method 500 of FIG. 5. Specifically, FIG. 7 illustrates steps performed by opportunity grouping module 410 of FIG. 4 and/or cohesive feature mapper 610 of FIG. 6.

At feature category block 705, the system (e.g., one or more instances of opportunity grouping module 410 of FIG. 4) receives, accesses, and/or obtains one or more data sets associated with a customer and categorizes the data by feature. As provided above, data sets may include, for example, cost data (e.g., cloud service usage costs, subscription fees, cost allocation, cost projections, etc.), asset data (e.g., hardware inventory, software licenses, cloud assets, asset lifecycles, etc.), metric data (e.g., system performance metrics, application metrics, user activity metrics, network traffic, etc.), application log data (e.g., error logs, transaction logs, access logs, system event logs, etc.), and other data associated with the customer’s data service subscriptions (e.g., service-level agreement data, subscription usage data, license compliance data, etc.). Upon receiving, accessing, or obtaining the data sets, opportunity grouping module 410 categorizes the features.

In embodiments, the data is categorized by a type of data. In such embodiments, the type of data may be used to determine how the data should be processed, analyzed, and/or utilized in the system. For example, textual data (e.g., customer feedback) may require natural language processing (NLP) for extracting and understanding information, while numerical data (e.g., costs and/or usage statistics) may need statistical methods. Recognizing data type ensures the system uses the correct processing pipeline. Furthermore, by categorizing data based on its type, the system can group similar data together, making it easier and/or more efficient to handle and analyze. This ensures that relevant features are processed together, improving the accuracy and relevance of predictions and/or recommendations. In embodiments the type of data may be discovered based on the file name of the feature (e.g., costs per week, etc.) and/or based on the contents of the feature. In such embodiments, the contents of the feature may be discovered using natural language processing (NLP) techniques including, for example, tokenization, part-of-speech tagging, named entity recognition (NER), sentiment analysis, and/or any other NLP technique that may discover the contents of the feature for the purpose of determining and categorizing data.

At blocks 710a-n, opportunity grouping module 410 categorizes the features into numerical data (e.g., values that represent quantities and/or can be used in mathematical operations), categorical data (e.g., variables that represent categories or groups and do not have inherent order or mathematical meaning, though in embodiments, they can be ordinal), timeseries data (e.g., data points that are ordered in time, such as daily, hourly, or monthly), and text data (e.g., unstructured data represented by natural language). In additional embodiments, additional and/or alternative categories may be used, including any category that could describe features of a data set.

At recursive feature fusion block 715, opportunity grouping module 410 may employ a recursive feature fusion model 720 to assign the categorized features into opportunity groups. As provided above, the recursive feature fusion model may use one or more of a correlation model, Least Absolute Shrinkage and Selection Operator L1 (LASSO L1) model, Chi-square model, and/or wrapper models such as forward selection, backward elimination, and recursive feature elimination (RFE)) or any other machine learning model that combines features from different sources or modalities in a recursive manner to improve prediction accuracy or enhance representation learning. Embodiments may also use multimodal neural networks, graph neural networks, long short-term memory networks, and/or recursive neural networks to perform the recursive feature fusion. At blocks 725a-n, opportunity grouping module 410 assigns the categorized data into opportunity groups based on the results and/or output of the recursive feature fusion model. In embodiments, a single feature may be categorized and assigned to one opportunity group. In other embodiments, a single feature may be categorized and assigned to multiple opportunity groups. For example, a feature describing a network usage of a customer may be assigned to a first opportunity group associated with total cost forecasting and a second opportunity group associated with anomaly detection.

In embodiments, the recursive feature fusion model identifies opportunity groups using features for a given category type (e.g., numeric, categorical, time series, text data, etc.) as a target feature (i.e., target variable) and apply different feature selection methods to identify other features (i.e., non-target variables) that are highly correlated with the target feature. As provided above, this can be done using one or more machine learning models. In embodiments, this process can be performed for any number or features, including for every feature. In embodiments, the opportunity groups may be stored in memory (e.g., one or more instances of data source 430 of FIG. 4).

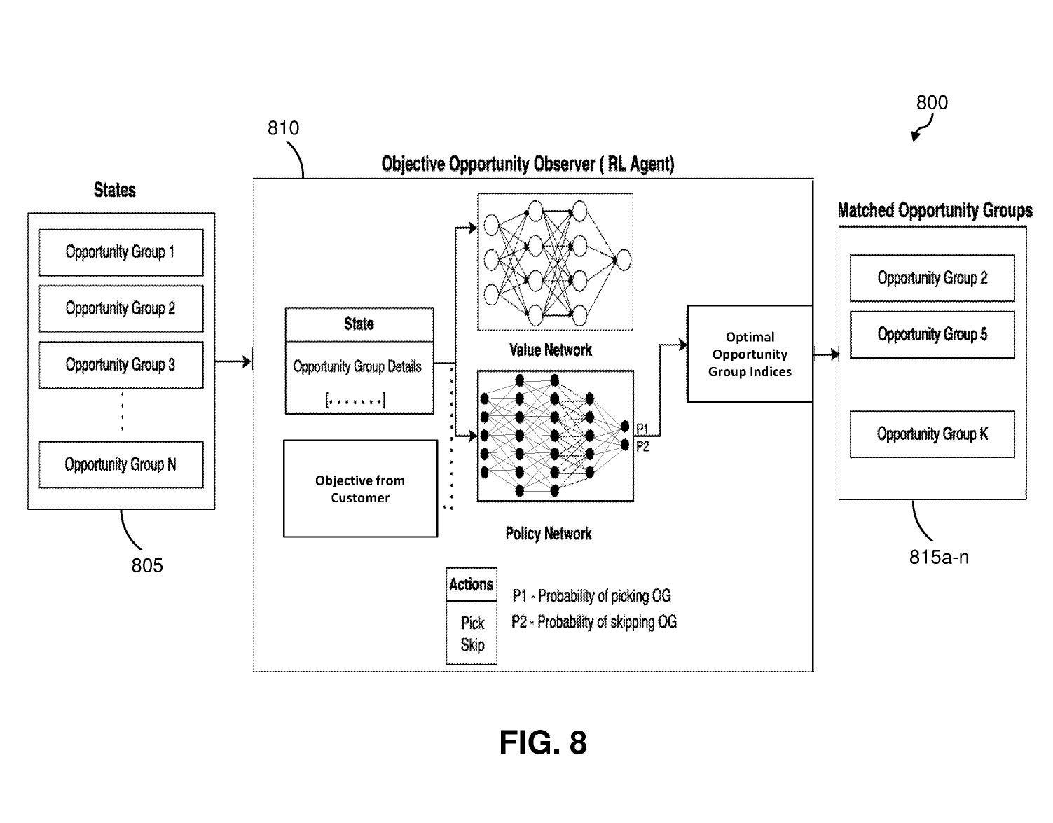

FIG. 8 shows exemplary flow diagram of exemplary environment 800 in accordance with aspects of the present invention. Steps of the method may be carried out in the environment of FIG. 4 and are described with reference to elements depicted in FIG. 4 and may include one or more steps, as described with respect to method 500 of FIG. 5. Specifically, FIG. 8 illustrates steps performed by objective and opportunity matching module 415 of FIG. 4 and/or objective opportunity observer 615 of FIG. 6.

At block 805, objective and opportunity matching module 415 of FIG. 4 receives, accesses, and/or obtains the opportunity groups (e.g., Opportunity Group 1, Opportunity Group 2, Opportunity Group 3, Opportunity Group N, etc.) generated by opportunity grouping module 410. At block 810, objective and opportunity matching module 415 employs an objective opportunity observer (e.g., a reinforcement learning agent) to determine opportunity groups that match and/or align with a customer’s objectives.

In embodiments, the objective opportunity observer 810 (e.g., a reinforcement learning agent) reforms the received opportunity groups into a different state of the respective received opportunity groups using a proximal policy optimization (PPO) algorithm. The PPO algorithm aims to improve the stability and efficiency of policy optimization and is designed to optimize the performance of agents in a stable and efficient manner.

In embodiments, objective opportunity observer 810 is further configured to receive, obtain, and/or access one or more objectives from a customer. The opportunity group state and the objectives are fed to one or more neural networks (e.g., multimodal neural networks, graph neural networks, long short-term memory networks, and/or recursive neural networks) to determine and/or identify optimal opportunity group indices. In embodiments, at least two neural networks may be used, a policy neural network that determines the type of policy for the formed opportunity group states and a value neural network that learns a mapping values of the opportunity group to the given objective, or in other words from the formed opportunity group states (or state-action pairs) to a scalar value. In embodiments, objective opportunity observer 810 may determine that an opportunity group meets at least one objective using a value neural network and a policy neural network.

In embodiments, the policy neural network learns how to map a given opportunity group state and/or customer objective to an action or decision. This action might represent how the opportunity group should be structured and/or selected to align with the customer’s goals. The policy neural network processes the inputs and generates a probability distribution over possible actions, where an action corresponds to selecting, prioritizing, and/or configuring a specific set of opportunities. For instance, in embodiments, if the action is a selection of opportunities, the policy network might output probabilities for choosing specific opportunities from the set. If the action is how to group the opportunities (e.g., forming clusters or specific opportunity sets), the policy network would output probabilities and/or configurations representing the best (e.g., more optimal based on the group state and/or customer objectives) groupings.

In embodiments, the value neural network evaluates the quality of the formed opportunity group by learning to map the opportunity group states to a scalar value, representing how well it aligns with the given objective. The value neural network predicts the expected reward and/or outcome of a specific action or configuration. The value neural network is trained to minimize the difference between its predicted value and the actual reward received after taking the action, guiding the policy neural network to improve decision-making.

In embodiments the objective opportunity observer 810 (e.g., a reinforcement learning agent) may also determine at least two probabilities. First, objective opportunity observer 810 may determine P1 which represents a probability of picking and/or selecting the opportunity group as being relatively associated with the customer’s objective. Second, objective opportunity observer 810 may determine P2, which represents a probability of skipping and/or not selecting the opportunity group as being relatively unrelated to the customer’s objective. In such embodiments, the probability may refer to a score that indicates whether the objective opportunity is associated with the customer’s objective.

At block 815a-n, objective opportunity observer 810 identifies at least one subset (i.e., matched opportunity groups) of the opportunity groups (e.g., Opportunity Group 2, Opportunity Group 5, Opportunity Group K, etc.) that correlates with and/or matches the customer’s objective. In embodiments, objective opportunity observer 810 ranks the subsets in order of their optimal opportunity group index. In other words, the higher the optimal opportunity group index for each subset, the higher that subset will be ranked relative to the other subsets.

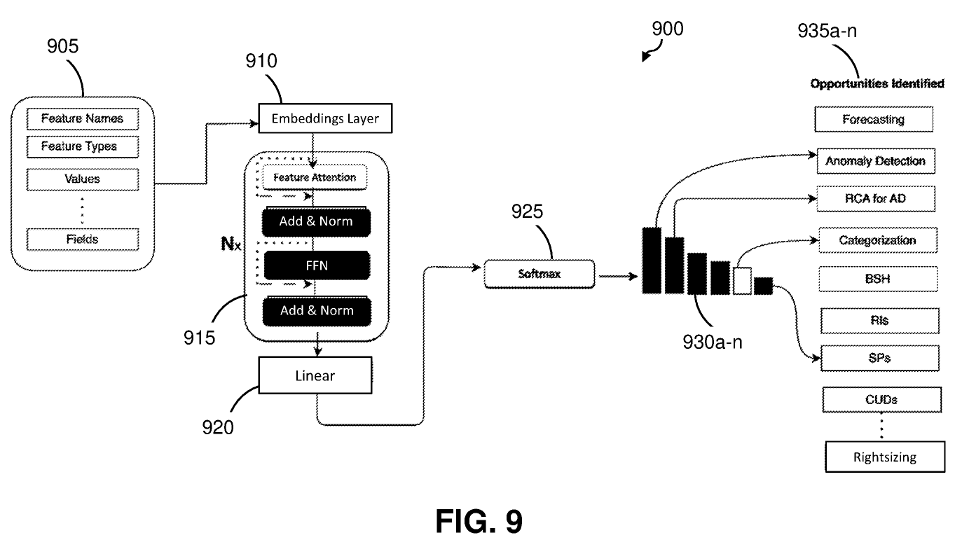

FIG. 9 shows an exemplary flow diagram of exemplary environment 900 in accordance with aspects of the present invention. Steps of the method may be carried out in the environment of FIG. 4 and are described with reference to elements depicted in FIG. 4 and may include one or more steps, as described with respect to method 500 of FIG. 5. Specifically, FIG. 8 illustrates steps performed by customer data analysis and correlation module 420 of FIG. 4 and/or OLM 620 of FIG. 6.

At block 905, customer data analysis and correlation module 420 extracts one or more features from subsets identified by the objective and opportunity matching module 415. In embodiments, the extracted features may include, for example, feature names, feature types, values, fields, and other information describing the features. At block 910, customer data analysis and correlation module 420 uses an embeddings layer to convert categorical data (such as words or tokens) into dense, continuous-valued vector representations. This provides, among other things, a way to map high-dimensional categorical data (e.g., a word index) into a lower-dimensional continuous space, making it easier for the model to learn useful patterns.

At block 915, customer data analysis and correlation module 420 uses a transformer block to process the embeddings, using self-attention (e.g., feature attention) and feedforward layers, to capture complex relationships and dependencies within the sequence. Specifically, in embodiments, the transformer block may include at least one self-attention layer, at least one add & normalize layer (e.g., layer normalization), and at least one feedforward neural network (FFN). The self-attention later allows each token in the input sequence to focus on (attend to) other tokens in the sequence in a way that is context-sensitive. It helps the model understand the relationships between different tokens, regardless of their position in the sequence. One add & normalize layer adds the self-attention layer to the output and normalizes the output of the addition, ensuring that the values are on a similar scale, which can help improve training stability. In embodiments, this is performed by subtracting the mean and dividing by the standard deviation across the features of the input. After the add & normalize layer, the output is passed through an FFN, which may include, for example, a linear transformation layer to increase dimensionality, one or more rectified linear unit (ReLU) activations to introduce non-linearity, and another linear transformation layer that reduces the dimensionality back to the original input size. The FFN layer may be followed by another add & normalize layer. In such embodiments, the transformer block outputs a linear value at linear block 920.

At block 925, customer data analysis and correlation module 420 passes the outputted linear value through a SoftMax. In embodiments, the SoftMax comprises a mathematical function used to convert raw output scores into probabilities and/or scores 930a-n, making the linear value interpretable and useful for classification tasks. This allows the customer data analysis and correlation module 420 to determine the number of features that identify opportunities 935a-n (e.g., forecasting, anomaly detection, root cause analysis (RCA) for anomaly detection (AD), categorization, business service health (BSH), risks (RIs), service providers (SPs), customer usage data (CUDs), rightsizing, and more). For example, one opportunity group may have a relatively high number of features that identify opportunities, while another opportunity group may have a relatively low number of features that identify opportunities. In embodiments, customer data analysis and correlation module 420 is configured to compare the determined probabilities and/or scores against a threshold to determine whether the probabilities and/or scores associated with an identified opportunity exceeds the threshold. In such embodiments, the threshold is determined based on a customer’s objectives. In other words, the threshold may be set at a predetermined level to ensure that the identified opportunities meet the customer’s objectives.

In embodiments, opportunities 935a-n represent viable candidate opportunities (e.g., services that could be offered by a service provider) for a new market based on customer data represent actionable insights derived from customer data that can be leveraged to identify potential new markets or areas of growth. These opportunities are based on the data analyzed above and are designed to align with one or more strategic goals of a customer. These viable opportunities can help the service provider explore new business avenues, optimize existing operations, and/or even detect market shifts that may lead to competitive advantages based on the insights derived from the customer data.

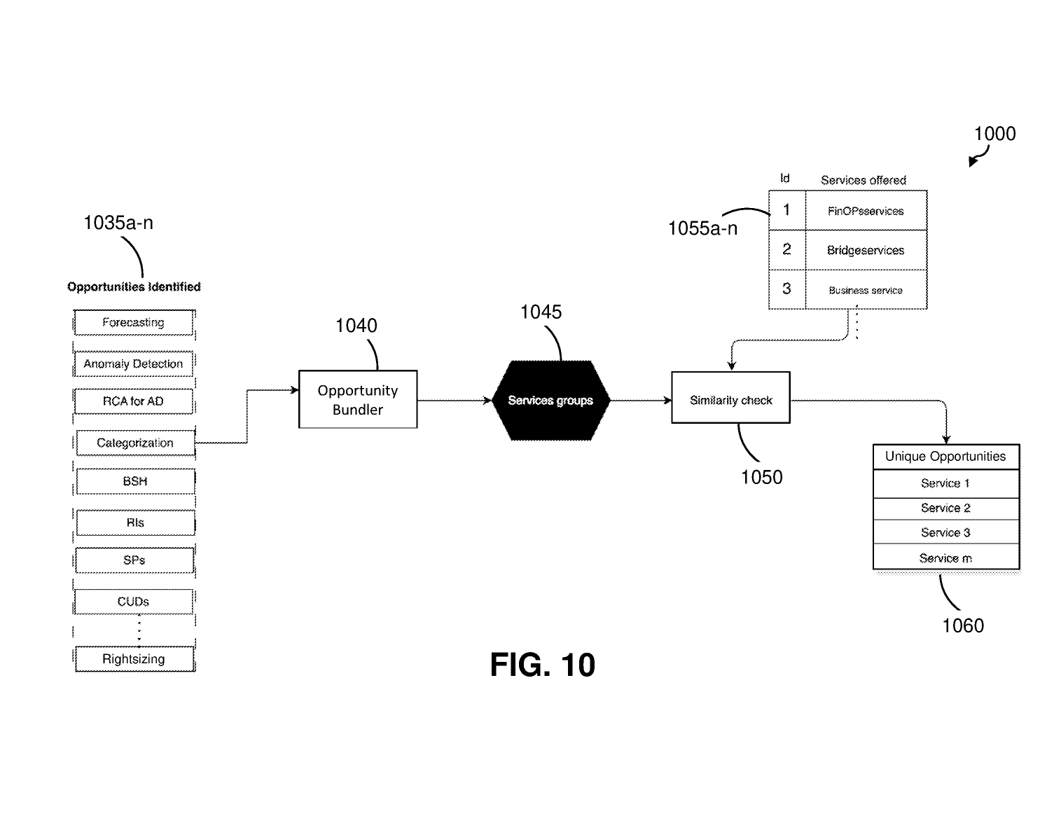

FIG. 10 shows an exemplary flow diagram of exemplary environment 1000 in accordance with aspects of the present invention. Steps of the method may be carried out in the environment of FIG. 4 and are described with reference to elements depicted in FIG. 4 and may include one or more steps, as described with respect to method 500 of FIG. 5. Specifically, FIG. 8 illustrates steps performed by opportunity recommendation module 425 of FIG. 4 and/or opportunity recommender 630 of FIG. 6.

At block 1040, opportunity recommendation module 425 receives and/or obtains opportunities identified 1035a-n (i.e., e.g., forecasting, anomaly detection, root cause analysis (RCA) for anomaly detection (AD), categorization, business service health (BSH), risks (RIs), service providers (SPs), customer usage data (CUDs), rightsizing, and more), as identified by customer data analysis and correlation module 420. The opportunity bundler of block 1040 operates as a clustering algorithm that groups, combines, coalesces the relevant opportunities into one group by considering one or more features. For example, in embodiments, the relevant opportunities may be grouped by features including, core objective, functional data, correlation, etc.

At service groups block 1045, the opportunity recommendation module 425 determines whether any services groups matched the identified opportunities. At block 1050, opportunity recommendation module 425 performs a similarity check where the service groups returned from block 1040 are matched to a list of services offered by a service provider. In embodiments, opportunity recommendation module 425 is configured to assign a correlation score based on the similarities between the service groups and the services offered by the service provider 1055a-n (e.g., financial operations services (FinOpsServices), sustainability operations services (SustainOpsServices), bridge services, business service, and more). In embodiments, the similarity check returns services whose correlation score exceeds a predetermined threshold. For example, in embodiments, the similarity check may only return services that have a correlation score that is 95% or above.

At block 1060, opportunity recommendation module 425 is configured to notify a user of the one or more candidate services and/or candidate opportunities (e.g., unique opportunities) 1060 that exceeds the confidence threshold (e.g., Service 1, Service 2, Service 3, Service m, etc.). In this manner opportunity recommendation module 425 determines the optimized services to help the customer meet its objective, based on the services offered by the service provider. In embodiments, candidate services for a customer and/or candidate opportunities for a service provider (e.g., unique opportunities) 1060 may represent business opportunities for a customer. In other words, the candidate opportunities (e.g., unique opportunities) 1060 represent potential business prospects that have not yet been explored or leveraged by the service provider. These opportunities are identified by opportunity recommendation module 425 based on their high correlation scores, meaning they are relevant to and aligned with the needs and/or objectives of one or more customers. By notifying the service provider of these opportunities, the module helps the service provider identify and act on opportunities that could enhance its business operations or market position, such as offering new services to customers or exploring new service areas provided by the service provider.

In such embodiments, the service subscription associated with the customer may be modified based on the customer’s response to the notification. In other words, when the customer is notified of the candidate solutions (e.g., candidate services) that exceed the correlation threshold, the customer may be given an option to modify the service subscription to include the unused solutions and/or to deny the proposed modification. In embodiments where a candidate opportunity is presented to a service provider, the service provider may be given an option to modify a service offering to include the candidate services for its customers and/or to deny the proposed modification.

In embodiments, a service provider could offer to perform the processes described herein. In this case, the service provider can create, maintain, deploy, support, etc., the computer infrastructure that performs the process steps of the present invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the present invention provides a computer-implemented method, via a network. In this case, a computer infrastructure, such as computer system/server 12 (FIG. 1), can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
grouping, by a processor set, one or more features of a first set of data associated with a customer into one or more sets of opportunity groups based on a feature evaluation using a first machine learning model;
identifying, by the processor set using at least one second machine learning model, a subset of the one or more sets of opportunity groups that meets at least one objective associated with the customer; and
identifying, by the processor set, one or more candidate services within the subset that exceed a correlation threshold for the one or more sets of opportunity groups based on the one or more features.

2. The computer-implemented method of claim 1, further comprising modifying, by the processor set, a data management service subscription associated with the customer by adding the one or more candidate services to the service subscription.

3. The computer-implemented method of claim 1, further comprising notifying, by the processor set, the customer of the one or more candidate services by sending a notification to a user device associated with the customer.

4. The computer-implemented method of claim 1, further comprising identifying at least one service provider offering based on the one or more candidate services .

5. The computer-implemented method of claim 1, further comprising determining, by the processor set, a correlation score associated with the one or more features using a plurality of correlation models, wherein the correlation score comprises a measure of correlation between the one or more features and features of the one or more sets of opportunity groups,
wherein the identifying one or more candidate services that exceed the correlation threshold comprises comparing the correlation score for the one or more features against the correlation threshold.

6. The computer-implemented method of claim 1, wherein the identifying the subset of the one or more sets of opportunity groups that meets the at least one objective associated with the customer is performed using a value neural network and a policy neural network.

7. The computer-implemented method of claim 6, wherein the value neural network maps values of the one or more sets of opportunity groups to a given objective, and the policy neural network determines a type of policy for the one or more sets of opportunity groups.

8. The computer-implemented method of claim 1, further comprising identifying at least one market opportunity based on the first set of data associated with the customer.

9. The computer-implemented method of claim 6, wherein the identifying the one or more candidate services that exceed the correlation threshold for the one or more sets of opportunity groups comprises comparing the subset of the one or more sets of opportunity groups that meets at least one objective associated with the customer against one or more services offered by a service provider.

10. A computer program product comprising one or more computer readable storage media having program instructions collectively stored on the one or more computer readable storage media, the program instructions executable to:
group one or more features of a first set of data associated with a customer into one or more sets of opportunity groups based on a feature evaluation using a trained first machine learning model, wherein the first machine learning model is trained by iteratively refining a set of training features until the trained first machine learning model meets a predefined level of accuracy;
identify, using at least one second machine learning model, a subset of the one or more sets of opportunity groups that meets at least one objective associated with the customer; and
identify one or more candidate services that exceed a correlation threshold for the one or more sets of opportunity groups based on the one or more features.

11. The computer program product of claim 10, wherein the executable instructions are further configured to notify the customer of the one or more candidate services by sending a notification to a user device associated with the customer.

12. The computer program product of claim 11, wherein the executable instructions are further configured to, responsive to a user response to the notification, modify a data management service subscription associated with the customer by adding the one or more candidate services that exceed the correlation threshold to the service subscription associated with the customer.

13. The computer program product of claim 10, wherein the executable instructions are further configured to:
determine a correlation score comprising a value indicating an amount of correlation between one or more candidate services and the subset,
wherein the identifying one or more candidate services further comprises comparing the correlation score against the correlation threshold.

14. The computer program product of claim 13, wherein the identifying the one or more candidate services that exceed the correlation threshold for the one or more sets of opportunity groups comprises comparing the subset of the one or more sets of opportunity groups that meets at least one objective associated with the customer against one or more services offered by a service provider.

15. The computer program product of claim 10, wherein the identifying the subset of the one or more sets of opportunity groups that meets the at least one objective associated with the customer is performed using a value neural network and a policy neural network, wherein the value neural network maps values of the one or more sets of opportunity groups to a given objective, and the policy neural network determines a type of policy for the one or more sets of opportunity groups.

16. A system comprising:
a processor, a computer readable memory, one or more computer readable storage media, and program instructions collectively stored on the one or more computer readable storage media, the program instructions executable to:
group one or more features of a first set of data associated with a customer into one or more sets of opportunity groups based on a feature evaluation using a trained first machine learning model;
identify, using at least one second machine learning model, a subset of the one or more sets of opportunity groups that meets at least one objective associated with the customer; and
identify one or more candidate services within the subset that exceed a correlation threshold for the one or more sets of opportunity groups based on the one or more features.

17. The system of claim 16, wherein the executable instructions are further configured to:
modify a data management service subscription associated with the customer by adding the one or more candidate services to the service subscription; and
notify the customer of the one or more candidate services by sending an electronic message to a user device associated with the customer.

18. The system of claim 16, wherein the executable instructions are further configured to:
determine a correlation score comprising a value indicating an amount of correlation between one or more candidate services and the subset,
wherein the identifying one or more candidate services further comprises comparing the correlation score against the correlation threshold.

19. The system of claim 18, wherein the identifying the one or more candidate services that exceed the correlation threshold for the one or more sets of opportunity groups comprises comparing the subset of the one or more sets of opportunity groups that meets at least one objective associated with the customer against one or more services offered by a service provider.

20. The system of claim 16, wherein the identifying the subset of the one or more sets of opportunity groups that meets the at least one objective associated with the customer is performed using a value neural network and a policy neural network, wherein the value neural network maps values of the one or more sets of opportunity groups to a given objective, and the policy neural network determines a type of policy for the one or more sets of opportunity groups
